(19) United States
(12) Patent Application Publication
(10) Pub. No.: US 2008/0165553 A1
(43) Pub. Date: Jul. 10, 2008

(54) Eighteen pulse rectification scheme for use with variable frequency drives

(76) Inventor: Mahesh M. Swamy, Gurnee, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/650,811

(22) Filed: Jan. 5, 2007

(51) Int. Cl. H02M 7/04; H02M 7/06

(52) U.S. Cl. 363/67; 363/126

(57) ABSTRACT

An AC/DC converter system comprises an input circuit for connection to a three phase AC source. An isolation transformer comprises a set of primary windings and first and second sets of secondary windings magnetically coupled to the set of primary windings. The first and second sets of secondary windings are phase shifted by select amounts from the set of primary windings. The set of primary windings is connected to the input circuit. An AC/DC converter comprises first, second and third three phase rectifiers, the first three phase rectifier being powered by the first set of secondary windings, the second three phase rectifier being powered by the second set of secondary windings, and the third three phase rectifier being powered by the input circuit. An impedance matching inductor is electrically connected between the input circuit and the third three phase rectifier. An output circuit is connected between the AC/DC converter and a DC load.

### CROSS REFERENCE TO RELATED APPLICATIONS

There are no related applications.

### FIELD OF THE INVENTION

The present invention relates to an AC/DC converter system and, more particularly, to an eighteen pulse rectifier using an isolation transformer with two sets of secondary windings.

### BACKGROUND OF THE INVENTION

Variable Frequency Drive (VFD) systems with diode rectifier front ends draw discontinuous current from the power system to which they are connected. This results in current harmonic distortion, which eventually translates into voltage distortion. Typically, the power system is robust and can handle significant amount of current distortion without showing signs of voltage distortion. However, in cases where the majority of the load on a distribution feeder is made up of Variable Frequency Drives with rectifier front ends, the current distortion becomes an important issue. Grid-connected transformers run hotter under harmonic loading. Harmonics can have a detrimental effect on emergency generators, telephones and other electrical equipment. When reactive power compensation (in the form of passive power factor improving capacitors) is used with non-linear loads, resonance conditions can occur that may result in even higher levels of harmonic voltage and current distortion thereby causing equipment failure and disruption of power service.

There are many ways of reducing the total current harmonic distortion (THD) caused by VFDs. Multi-pulse techniques are popular because they do not interfere with the existing power system from resonance point of view and they are robust and perform well. Harmonic distortion concerns are serious when the power ratings of the VFD load increases. Large power VFDs are gaining in popularity due to their low cost and impressive reliability. Use of large power VFDs increases the amplitude of low order harmonics that can significantly impact the power system. In many large power installations, current harmonic distortion levels achievable using twelve-pulse techniques are insufficient to meet the levels recommended in IEEE Standard 519-1992. As a result eighteen-pulse VFD systems are being proposed to achieve superior harmonic performance compared to the traditional twelve-pulse systems.

A typical 3-phase full bridge rectifier is said to be a 6-pulse rectifier because there are six distinct diode pair conduction intervals in one complete electrical cycle. In such a 6-pulse rectifier with no DC bus capacitor, the characteristic harmonics are non-triplen odd harmonics (e.g., 5th, 7th, 11th, etc.). In general, the characteristic harmonics generated by a semiconductor rectifier is given by:

h=kq±1 (1)

where h is the order of harmonics; k is any integer, and q is the pulse number of the rectifier (six for a 6-pulse rectifier). The per unit value of the characteristic harmonics present in the theoretical current waveform at the input of the semiconductor converter is given by 1/h. In practice, the observed per unit value of the harmonics is much greater than 1/h. From these observations, it is clear that increasing the pulse number from 6 to either 12 or 18 will significantly reduce the amplitude of low order harmonics and hence the total current harmonic distortion.

The eighteen-pulse systems have become economically feasible due to the recent advances in autotransformer techniques that help reduce the overall size and cost and achieve low total current harmonic distortion. When employing autotransformers, care should be taken to force the different rectifier units to properly share the current. The eighteen-pulse configuration lends itself better in achieving this goal compared to the twelve-pulse scheme.

For eighteen-pulse operation, there is a need for three sets of 3-phase AC supply that are phase shifted with respect to each other by 20 electrical degrees. Typically, this is achieved using a four winding isolation transformer that has one set of primary windings and three sets of secondary windings, as shown in FIG. 1. One set of secondary winding is in phase with the primary winding, while the other two sets are phase shifted by +20 electrical degrees and −20 electrical degrees, respectively, with the primary. This arrangement yields three phase-shifted supplies that allow eighteen-pulse operation. The use of a DC link choke is optional. The leakage inductance of the transformer may be sufficient to smooth the input current and improve the overall current harmonic distortion levels. One disadvantage of the scheme shown in FIG. 1 is that the phase-shifting isolation transformer is bulky and expensive.

Instead of using ±20 degree phase-shifted outputs from an isolation transformer for eighteen-pulse operation, a nine-phase supply can be used, where each phase lags the other by 40 electrical degrees. U.S. Pat. No. 5,455,759 shows a nine-phase AC supply using a wye-fork with a tertiary delta winding to circulate triplen harmonics. The size of the autotransformer is large and there is need for additional series impedance to smoothen the input AC currents. The rating of the transformer is about 70% of the rating of the load. If the series inductance is not used, then the output DC voltage is about 4.3% higher than that achieved when a standard six-pulse rectifier is used.

U.S. Pat. No. 5,124,904 shows a nine-phase AC supply using a delta-fork that does not require any additional delta winding. In this configuration, the average DC output voltage is about 14% higher than that obtained using a standard six-pulse rectifier scheme. This can potentially stress the DC bus capacitors and the IGBTs in the inverter section of a VFD. In order to overcome this, additional teaser windings are used. These windings not only add cost and increase the overall rating of the transformer, but also cause imbalance that results in higher than normal circulating currents in the delta windings, which need to be accommodated. The harmonic performance is good but the overall size is large with rated current flow through the teaser windings.

In order to overcome the 14% higher average DC bus voltage observed in the previous configuration, a modification of the configuration was proposed in the U.S. Pat. No. 5,619,407. The harmonic performance is similar and the average DC bus voltage is equal to that observed in six-pulse rectifiers. Similar to the previous configuration, the stub winding currents are high and the teaser winding needs to carry rated load current making the overall transformer big in size and expensive to wind.

In autotransformer configurations using stub and/or teaser windings, discussed above, the overall size and rating of the autotransformer is higher than the optimal value. Use of stub windings typically results in poor utilization of the core and involves more labor to wind the coils. A polygon type of autotransformer is better than stub type autotransformer from size and core utilization points of view. A polygon type autotransformer is shown in U.S. Pat. No. 4,876,634. This configuration requires the use of inter-phase transformers and input AC inductors to achieve low total current harmonic distortion. The reason is that the outputs are not equally spaced to achieve a nine-phase AC supply as in the previous configurations. The polygon autotransformer provides +/−20° phase shifted outputs to achieve eighteen-pulse operation.

A popular eighteen-pulse autotransformer configuration is shown in U.S. Pat. No. 6,525,951. This configuration is a modified version of the configuration shown in the '759 patent. A delta-connected tertiary winding is included in the wye fork. This construction is called a windmill construction. Initially, the windmill structure was present in each phase and the size of the transformer was still big. The kVA rating was about 60%. By removing the windmill structure from two of the three phases, it was shown that the performance remained equally good. By adopting the modified structure of the 759 patent, the kVA rating of the autotransformer was reduced from 60% to 55%.

In the eighteen-pulse autotransformer systems, the change of current from one conducting diode pair to the other is quite sudden. Though the RMS current rating may not exceed the current rating of the diode, attention should be given to the di/dt of the current through the diodes. Since the use of autotransformer systems with eighteen-pulse operation is, recent, there is not much statistical data available to comment on the di/dt issue with diodes when used in conjunction with eighteen-pulse autotransformer techniques.

Some important drawbacks of the topologies discussed in the prior art are as follows:
a. Autotransformer based topologies require significant input impedance to smooth the current and reduce the overall input current distortion,
b. Autotransformer techniques utilize complex winding structures, either of the stub-type or the polygon type. These transformers are labor intensive to manufacture and result in poor core utilization,
c. Because of complicated winding structure and the fact that partial turns are not practically feasible to build, the error resulting in rounding off can be significant that influences the final performance. This is one reason why input impedance of significant value is needed to account for such aberrations, and

d. The change of current from one conducting diode pair to the other is quite sudden in all autotransformer configurations. This causes higher than normal di/dt stress in rectifier diodes and should be considered while designing systems required to have high reliability.

The present invention is directed to solving one or more of the problems discussed above in a novel and simple manner.

### SUMMARY OF THE INVENTION

The present invention is directed to an AC/DC converter system and, more particularly, to an eighteen pulse rectifier using an isolation transformer with two sets of secondary windings.

In accordance with one aspect of the invention there is described an AC/DC converter system comprising an input circuit for connection to a three phase AC source. An isolation transformer comprises a set of primary windings and first and second sets of secondary windings magnetically coupled to the set of primary windings. The first and second sets of secondary windings are phase shifted by select amounts from the set of primary windings. The set of primary windings is connected to the input circuit. An AC/DC converter comprises first, second and third three phase rectifiers, the first three phase rectifier being powered by the first set of secondary windings, the second three phase rectifier being powered by the second set of secondary windings, and the third three phase rectifier being powered by the input circuit. An output circuit is connected between the AC/DC converter and a DC load.

The first and second sets of secondary windings may be phase shifted by equal and opposite amounts from the set of primary windings.

The first and second sets of secondary windings may be phase shifted by +20 electrical degrees and −20 electrical degrees, respectively, from the set of primary windings.

Each of the three phase rectifiers may comprises six pulse rectifiers. The input circuit may comprise a three phase inductor and an impedance matching three phase inductor electrically connected between the input circuit and the third three phase rectifier.

The output circuit may comprise parallel connected DC outputs from the bridge rectifiers connected through an output inductor to the DC load.

It is a feature of the invention that the set of primary windings comprises three main primary windings and each set of secondary windings comprises three main secondary windings, each in phase with corresponding ones of the three main primary windings, electrically connected to three teaser secondary windings, each in phase with adjacent ones of the three main primary windings, resulting in a vector phase shifted from the phase of the corresponding one of the three main primary windings.

There is disclosed in accordance with another aspect of the invention an eighteen pulse converter system comprising an input circuit for connection to a three phase AC source. An isolation transformer comprises a set of primary windings and first and second sets of secondary windings magnetically coupled to the set of primary windings, the first and second sets of secondary windings phase shifted by select amounts from the set of primary windings, and the set of primary windings connected to the input circuit. An eighteen pulse rectifier comprises first, second and third six pulse rectifiers, the first six pulse rectifier being powered by the first set of secondary windings, the second six pulse rectifier being powered by the second set of secondary windings, and the third six pulse rectifier being powered by the input circuit. An output circuit is connected between the AC/DC converter and a DC load.

There is disclosed in accordance with a further aspect of the invention an AC/DC converter system comprising an input circuit comprising a three phase inductor for connection to a three phase AC source. An isolation transformer comprises a set of primary windings and first and second sets of secondary windings magnetically coupled to the set of primary windings, the first and second sets of secondary windings phase shifted by select amounts from the set of primary windings, the set of primary windings connected to the input circuit. An AC/DC converter comprises first, second and third three phase rectifiers each for converting AC power to DC power. The first three phase rectifier is electrically connected to the first set of secondary windings. The second three phase rectifier is electrically connected to the second set of secondary windings. An impedance matching inductor is electrically connected between the input circuit and the third three phase rectifier. An output circuit is connected between the AC/DC converter and a DC load.

Further features and advantages of the invention will be apparent from the specification and the drawings.

### BRIEF DESCRIPTION OF THE DRAWINGS

FIG. 1 is a schematic representation of a prior art eighteen-pulse converter circuit fed from a phase shifted isolation transformer;

FIG. 2 is a schematic representation of an eighteen-pulse converter circuit fed from a phase shifted isolation transformer in accordance with the invention;

FIG. 3 is a vector representation of one of the sets of secondary windings in the isolation transformer of FIG. 2;

FIG. 4 is a series of curves that graphically illustrate the components that form the primary side input current, I_{X}; and

FIG. 5 is a series of curves that graphically illustrate the current in being composed of I_{L} and I_{X}.

### DETAILED DESCRIPTION OF THE INVENTION

In accordance with the invention, an isolation transformer uses two sets of secondary windings, reducing size and cost. An eighteen-pulse rectifier uses one six-pulse rectifier circuit directly connected to the AC source via some balancing inductance to match the inductance in front of the other two sets of six-pulse rectifier circuits to achieve eighteen-pulse operation.

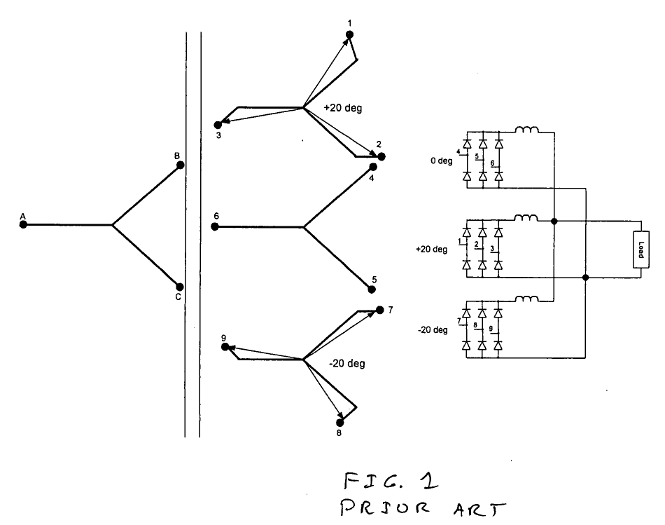

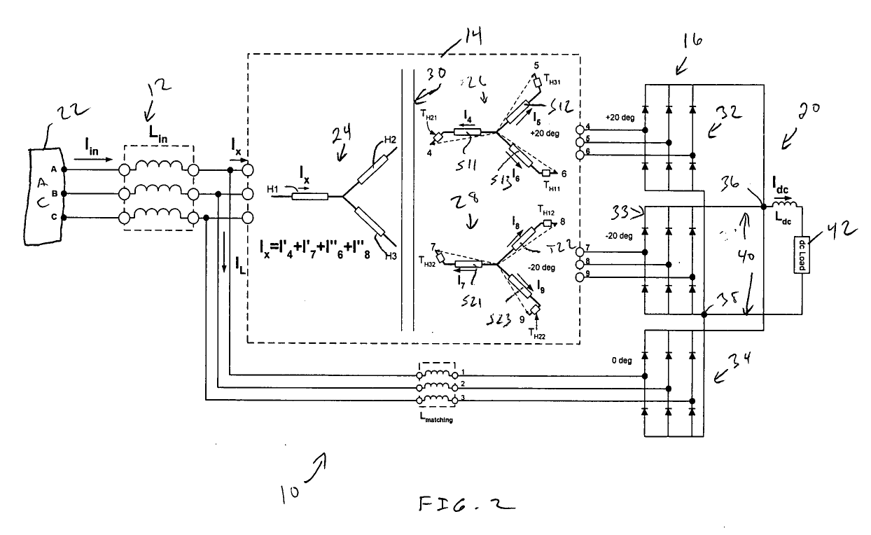

The resulting scheme has two six-pulse rectifiers powered via a phase-shifting isolation transformer, while the third six-pulse rectifier is fed directly from the AC source via a matching-impedance. Such an eighteen-pulse arrangement is shown in FIG. 2. The phase-shifting transformer feeding two of the three six-pulse rectifiers is sized to handle ⅔rd the rated power. Similarly, the matching inductor is sized to carry only ⅓rd the rated current. This arrangement results in the overall size of the transformer and matching inductor combination to be smaller and less expensive than the four winding arrangement of FIG. 1, discussed above.

Particularly, an AC/DC converter system 10 comprises an input circuit 12, an isolation transformer 14, an eighteen-pulse rectifier 16, and an output circuit 20. The input circuit 12 comprises a three phase inductor L_{IN} connected via terminals A, B and C to a three phase AC source 22. The isolation transformer 14 comprises a set 24 of primary windings and first and second sets 26 and 28 of secondary windings magnetically coupled via a core 30 to the set 24 of primary windings. The first and second sets 26 and 28 of secondary windings are phase shifted by select amounts from the set 24 of primary windings. The first and second sets 26 and 28 of secondary windings are phase shifted by +20 electrical degrees and −20 electrical degrees, respectively, from the set 24 of primary windings, in the illustrated embodiment of the invention. As is apparent, other phase shift amounts could be used. The set 24 of primary windings is connected to the input circuit inductor L_{IN}.

The eighteen-pulse rectifier 16 comprises first, second and third conventional three phase rectifiers 32, 33 and 34, each for converting AC power to DC power, as is well known. Each three phase rectifier 32-34 comprises a full bridge and is said to be a six-pulse rectifier because there are six distinct diode pair conduction intervals in one complete electrical cycle, as is conventional. The first three phase rectifier 32 is electrically connected to the first set 26 of secondary windings via nodes 4, 5 and 6. The second three phase rectifier 33 is electrically connected to the second set 28 of secondary windings via nodes 7, 8 and 9. An impedance matching inductor L_{matching} is electrically connected between the input circuit inductor LIN and the third three phase rectifier 34 via nodes 1, 2 and 3.

The output circuit 20 connects the DC outputs of the three phase rectifiers 32-34 in parallel between nodes 36 and 38 to define a DC bus 40. An output inductor L_{dc} is connected between the node 36 and a DC load 42. The AC/DC converter system 10 is particularly adapted for use with a DC load 42 in the form of a variable frequency drive. Such a drive typically includes an inverter for converting the DC power on the bus to AC power for operating the drive at a select frequency. However, the system 10 can be used with other conventional DC loads.

The phase shift in the isolation transformer 14 is achieved by winding extra teaser windings on appropriate limbs of the transformer core 30, which may be any known configuration. The primary windings are labeled H1, H2 and H3 and are electrically connected in a wye configuration. The first set 26 of secondary windings includes main windings S11, S12 and S113 in phase with the respective primary windings H1, H2 and H3 and electrically connected in a wye configuration. The second set 28 of secondary windings includes main windings S21, S22 and S23 in phase with the respective primary windings H1, H2 and H3 and electrically connected in a wye configuration. The extra teaser windings are electrically connected to the main windings of phases that are adjacent, resulting in a vector that is phase shifted with respect to the corresponding phase on the primary side. The teaser windings are marked “T” with subscript denoting the phase that they are wound on. For example, T_{H21} denotes a teaser winding that is wound on the H2 winding of the primary side of the isolation transformer and is used in the first set 26 of secondary winding to yield a phase shift of +20 degrees.

In order to estimate the total current harmonic distortion in the input line current Iᵢₙ, the following assumptions are made:
a. The inductance in the dc bus 40 is large enough to assume that the dc bus current has no ripple,
b. The leakage inductance of the isolation transformer 14 is neglected so that the current through the windings is assumed to be rectangular in shape,
c. The harmonic analysis is carried out at rated load current, I_{dc},
d. The windings of the isolation transformer 14 and the matching inductance L_{matching} are well balanced such that the load current I_{dc} is equally shared among the three different paths. In other words, the height of the rectangular current pattern in each of the parallel paths is I_{dc}/3,

e. The primary winding marked as H1, H2, and H3, have N₁ turns, the long part of each secondary fork, the main winding, has N₂ turns and the short part of the secondary fork, the teaser winding, has N₃ turns. The vector combination of N₂ and N₃ should yield N₁ to result in a 1:1 transformation ratio.

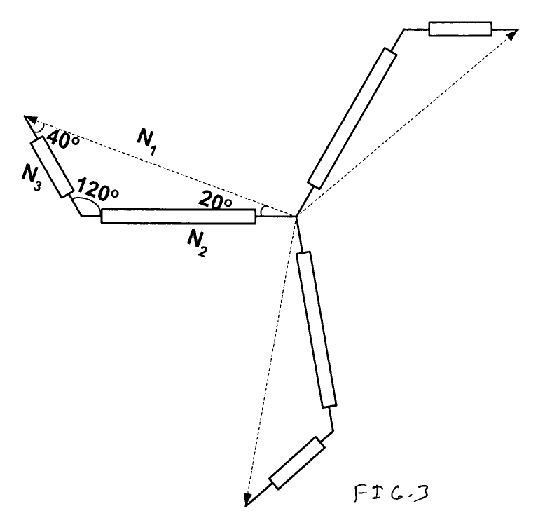

In order to determine the contribution of secondary currents in the primary side input current, it is important to determine the turns ratios among N1, N2, and N3. This is achieved using the expanded vector diagram shown in FIG. 3.

From FIG. 3, the turns ratio in terms of N₁ is computed as follows:

$$\frac{{N}_{1}}{sin ( 120 )} = \frac{{N}_{2}}{sin ( 40 )} = \frac{{N}_{3}}{sin ( 20 )} \\ {N}_{2} = 0.7422 {N}_{1} \\ {N}_{3} = 0.3949 {N}_{1} \qquad ( 2 )$$

From equation (2) and FIG. 3, the components that make up the primary current I_{X} are derived next.

$${I}_{X} = {I}_{4}^{′} + {I}_{7}^{′} + {I}_{6}^{″} + {I}_{8}^{″} \\ {I}_{4}^{′} = 0.7422 \cdot \frac{{I}_{dc}}{3} ∠20° \\ {I}_{7}^{′} = 0.7422 \cdot \frac{{I}_{dc}}{3} ∠ - 20 ° \\ {I}_{6}^{″} = 0.3949 \cdot \frac{{I}_{dc}}{3} ∠ - 100 ° \\ {I}_{8}^{″} = 0.3949 \cdot \frac{{I}_{dc}}{3} ∠ - 140 ° \qquad ( 3 )$$

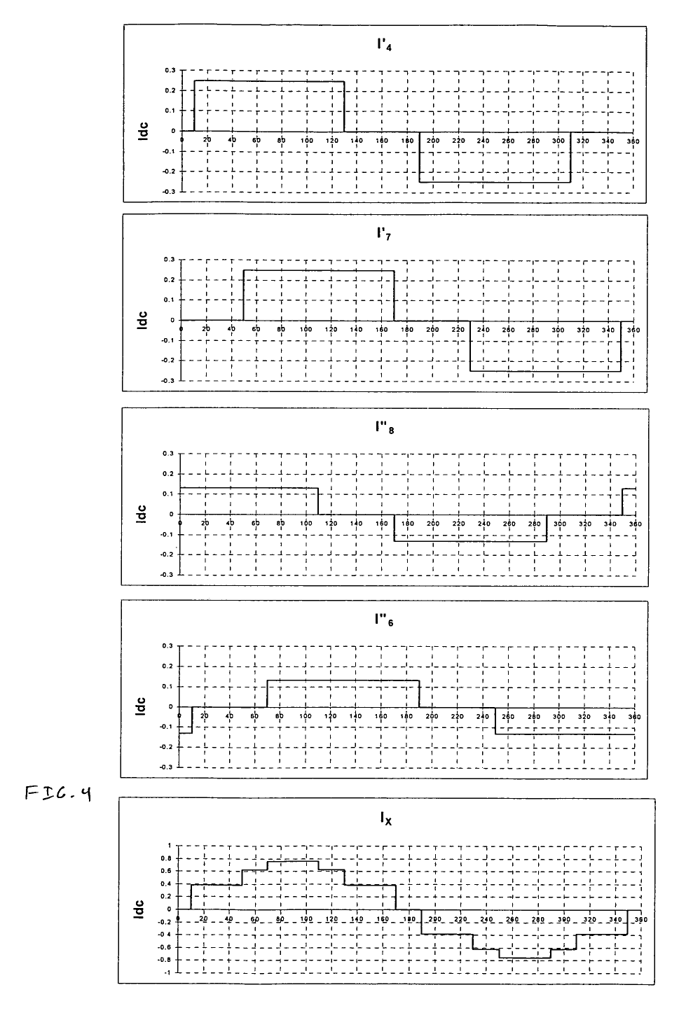

The current wave shape of I_{X} and the relative positions of the components of I_{X}, referenced in FIG. 3, are shown in FIG. 4.

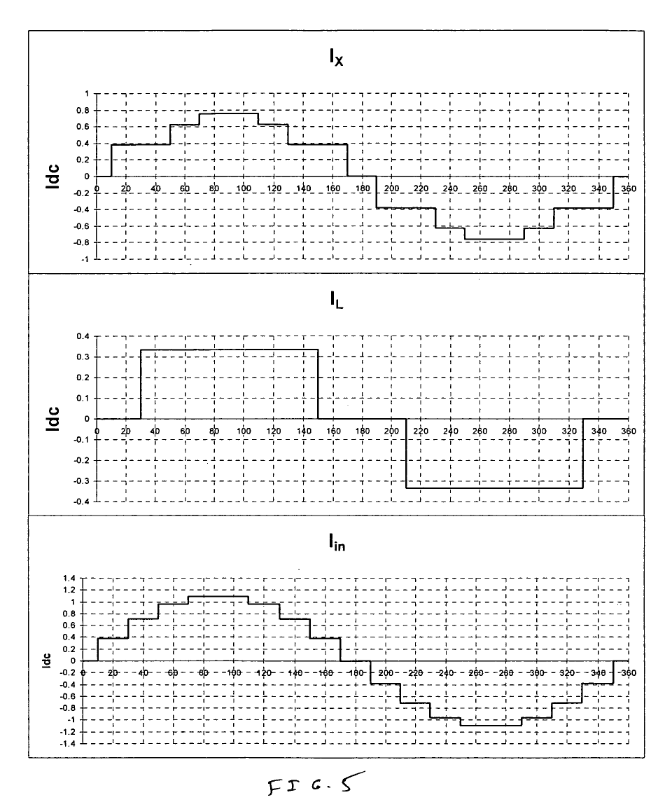

The input current Iᵢₙ drawn from the ac source 22 is a combination of the input current Iₓ into the transformer and the current I_{L} flowing through the matching inductor, L_{matching}, directly into the third bridge rectifier 34. A graphic illustration of the formation of Iᵢₙ is shown in FIG. 5. The waveform corresponding to Iᵢₙ in FIG. 5 is used to mathematically estimate the total input current harmonic distortion.

The staircase waveform shown in FIG. 5 for Iᵢₙ is analyzed using Fourier series. The analysis yields the theoretical value of the total input current harmonic distortion. The Fourier analysis is presented below:

$${I}_{i n} = {I}_{0} + {\sum }_{n = 1}^{n = ∞} {a}_{n} \cdot cos ( n θ ) + {\sum }_{n = 1}^{n = ∞} {b}_{n} \cdot sin ( n θ ) \\ {I}_{0} = \frac{1}{2 \cdot π} \cdot {\int }_{0}^{2 π} {I}_{i n} \cdot d θ ; \\ {a}_{n} = \frac{2}{π} \cdot {\int }_{0}^{π} {I}_{i n} \cdot cos ( n θ ) \cdot d θ ; \\ {b}_{n} = \frac{2}{π} \cdot {\int }_{0}^{π} {I}_{i n} \cdot sin ( n θ ) \cdot d θ \qquad ( 4 )$$

On inspecting the waveform shown in FIG. 5, the following observations are made:
a. The waveform of Iᵢₙ does not have any dc component. This means that the dc component representation (I₀) in equation 4 is zero.
b. Iᵢₙ is symmetrical about the x-axis. This means that there are no even harmonics.
c. Iᵢₙ exhibits mirrored symmetry about the n axis. This means that Iᵢₙ is an odd function and not an even function. In other words, this property would render the coefficient aₙ to be zero.

d. From observations mentioned in items a through c, only the coefficient bₙ needs to be computed.

Based on the observations made above, the coefficient bₙ is computed.

$${b}_{n} = \frac{2}{π} \cdot {\int }_{0}^{π} {I}_{i n} \cdot sin ( n θ ) \cdot d θ \\ {b}_{n} = \frac{2 \cdot {I}_{DC}}{π} \cdot \{ {\int }_{π / 18}^{π / 6} 0.379 \cdot sin ( n θ ) \cdot d θ + {\int }_{π / 6}^{5 π / 18} 0.712 \cdot sin ( n θ ) \cdot d θ + {\int }_{5 π / 18}^{7 π / 18} 0.959 \cdot sin ( n θ ) \cdot d θ + {\int }_{7 π / 18}^{11 π / 18} 1.09 \cdot sin ( n θ ) \cdot d θ + {\int }_{11 π / 18}^{13 π / 18} 0.959 \cdot sin ( n θ ) \cdot d θ + {\int }_{13 π / 18}^{5 π / 6} 0.712 \cdot sin ( n θ ) \cdot d θ + {\int }_{5 π / 6}^{17 π / 18} 0.379 \cdot sin ( n θ ) \cdot d θ \} \\ {b}_{n} = \frac{2 \cdot {I}_{DC}}{π} \cdot \{ \frac{0.666}{n} \cdot cos ( n π / 6 ) + \frac{0.494}{n} \cdot cos ( 5 n π / 18 ) + \frac{0.758}{n} \cdot cos ( n π / 18 ) + \frac{0.264}{n} \cdot cos ( 7 n π / 18 ) \} \qquad ( 5 )$$

From equation (5), the following observations can be made:
a. The total current harmonic distortion is computed to be 8.8% for the assumed staircase waveform.
b. There does not exist any triplen harmonics.
c. The first set of lowest order harmonics encountered is the 17th and the 19th.
d. The 17th is observed to be of negative sequence, while the 19th is seen to be of positive sequence.

From the waveform for the primary side input current Iₓ of the transformer configuration, the VA rating of the transformer is computed.

$${I}_{X} = \sqrt{\frac{1}{π} \cdot \{ {\int }_{0}^{π} {( {i}_{4}^{′} + {i}_{7}^{′} + {i}_{6}^{″} + {i}_{8}^{″} )}^{2} \cdot d θ} \\ {I}_{X} = \sqrt{\begin{matrix}\begin{matrix}\frac{{I}_{DC}^{2}}{π} \cdot \{ {\int }_{π / 18}^{5 π / 18} {0.379}^{2} \cdot d θ + {\int }_{5 π / 18}^{7 π / 18} {0.626}^{2} \cdot d θ + \\ {\int }_{7 π / 18}^{11 π / 18} {0.758}^{2} \cdot d θ + {\int }_{11 π / 18}^{13 π / 18} {0.626}^{2} \cdot d θ +\end{matrix} \\ {\int }_{13 π / 18}^{17 π / 18} {0.379}^{2} \cdot d θ \}\end{matrix}} \\ {I}_{X} = \sqrt{\frac{4 \cdot {I}_{DC}^{2}}{18} \cdot \{ {0.626}^{2} + {0.758}^{2} + ( 2 \cdot {0.379}^{2} ) \}} \\ {I}_{X} = 0.5278 {I}_{DC} \qquad ( 6 )$$

The VA rating of the phase-shifting isolation transformer 14 is computed by multiplying the RMS value of the input current with the RMS value of the applied voltage and further multiplying the result with three to account for all the windings.

$${VA}_{xfmr} = 3 \cdot {V}_{LN} , {I}_{X} = 3 \cdot {V}_{LN} , 0.5278 {I}_{DC} = 1.5834 {V}_{LN} , {I}_{DC} \\ {P}_{out} = \frac{3 \cdot \sqrt{3} \cdot \sqrt{2} \cdot {V}_{LN}}{π} \cdot {I}_{DC} \\ \frac{{VA}_{xfmr}}{{P}_{out}} = \frac{1.5834 π}{3 \cdot \sqrt{6}} = 0.677 \qquad ( 7 )$$

From equation (7), it is seen that the transformer 14 processes about ⅔rd the rated output power. This conclusion matches the physical reasoning because the power processed by the non-phase shifted section that consists of the matching inductance L_{matching}, is about ⅓rd the rated output power.

It is important to point out salient differences between the prior art autotransformer systems and the AC/DC converter system 10 in accordance with the invention using the isolation transformer 14. These differences include:
a. In autotransformer systems, the harmonic cancellation is primarily due to the reflected current waveform on to the branch carrying the main phase current. Due to non-ideal coupling and leakage effects, the cancellation is not complete and so the harmonic performance is not close to theoretical levels. In the described AC/DC converter system 10, the harmonic cancellation is not dependent on the idealness of the magnetic coupling. It is achieved by current combination at the input junction point between I_{X} and I_{L} in FIG. 2.
b. Due to the non-ideal coupling, most autotransformer systems need to use large values of input inductor Lᵢₙ to comply with harmonic standards prevalent in the Industry, particularly IEEE 519-1992. The typical value of Lᵢₙ used in such cases range from 0.05 pu to 0.075 pu. This adds cost and increases the overall size significantly. Input inductors are associated with voltage drop and need to be compensated elsewhere. Due to the different way in which harmonic cancellation is achieved in the AC/DC converter system 10, the reliance on an external inductor to achieve good performance is minimal. Typical values needed for the AC/DC converter system 10 range from 0.015 pu to 0.02 pu to meet 5% THID requirements and no external inductor when 8% or higher THID is required to be met. This results in a more compact, less expensive, more efficient system.
c. Autotransformer systems rely heavily on stub windings. Stub windings are difficult to be practically implemented resulting in wastage of copper and poor utilization of the core. Manufacturing time is also longer due to the many complicated interconnections that need to be performed. In contrast, the AC/DC converter system 10 relies on standard isolation transformer techniques and is easy to manufacture with very few windings. Core and copper utilization is better, resulting in a more efficient and less expensive product.
d. In autotransformer systems, the transition of current from one diode pair to the next is sharp and is associated with high di/dt. In contrast, in the AC/DC converter system 10, the transition is observed to be much slower and is associated with a lower di/dt. This results in less stress to the rectifier diodes and improves the mean time between failures (MTBF).

Thus the AC/DC converter system 10 in accordance with the invention uses a topology that is easy to manufacture, less complicated, and provides superior performance. It has good copper and core utilization and hence is less expensive. This topology results in a current THD of less than 5% when used in conjunction with a 0.02 pu value of input inductance. The input inductance is optional and THID distortion level of less than 7% is observed when no input-inductance is used.

We claim:

1. An AC/DC converter system comprising:
an input circuit for connection to a three phase AC source;
an isolation transformer comprising a set of primary windings and first and second sets of secondary windings magnetically coupled to the set of primary windings, the first and second sets of secondary windings phase shifted by select amounts from the set of primary windings, the set of primary windings connected to the input circuit;
an AC/DC converter comprising first, second and third three phase rectifiers, the first three phase rectifier being powered by the first set of secondary windings, the second three phase rectifier being powered by the second set of secondary windings, and the third three phase rectifier being powered by the input circuit; and
an output circuit for connection between the AC/DC converter and a DC load.

2. The AC/DC converter system of claim 1 wherein the first and second sets of secondary windings are phase shifted by equal and opposite amounts from the set of primary windings.

3. The AC/DC converter system of claim 1 wherein the first and second sets of secondary windings are phase shifted by +20 electrical degrees and −20 electrical degrees, respectively, from the set of primary windings.

4. The AC/DC converter system of claim 1 wherein each of the three phase rectifiers comprises a six pulse rectifier.

5. The AC/DC converter system of claim 1 wherein the input circuit comprises a three phase inductor.

6. The AC/DC converter system of claim 5 further comprising an impedance matching three phase inductor electrically connected between the input circuit and the third three phase rectifier.

7. The AC/DC converter system of claim 1 wherein the output circuit comprises parallel connected DC outputs from the bridge rectifiers connected through an output inductor to the DC load.

8. The AC/DC converter system of claim 1 wherein the set of primary windings comprises three main primary windings and each set of secondary windings comprises three main secondary windings, each in phase with corresponding ones of the three main primary windings, electrically connected to three teaser secondary windings, each in phase with adjacent ones of the three main primary windings, resulting in a vector phase shifted from the phase of the corresponding one of the three main primary windings.

9. An eighteen pulse converter system comprising:
an input circuit for connection to a three phase AC source;
an isolation transformer comprising a set of primary windings and first and second sets of secondary windings magnetically coupled to the set of primary windings, the first and second sets of secondary windings phase shifted by select amounts from the set of primary windings, the set of primary windings connected to the input circuit;
an eighteen pulse rectifier comprising first, second and third six pulse rectifiers, the first six pulse rectifier being powered by the first set of secondary windings, the second six pulse rectifier being powered by the second set of secondary windings, and the third six pulse rectifier being powered by the input circuit; and
an output circuit for connection between the AC/DC converter and a DC load.

10. The eighteen pulse converter system of claim 9 wherein the first and second sets of secondary windings are phase shifted by equal and opposite amounts from the set of primary windings.

11. The eighteen pulse converter system of claim 9 wherein the first and second sets of secondary windings are phase shifted by +20 electrical degrees and −20 electrical degrees, respectively, from the set of primary windings.

12. The eighteen pulse converter system of claim 9 wherein the input circuit comprises a three phase inductor.

13. The eighteen pulse converter system of claim 12 further comprising an impedance matching three phase inductor electrically connected between the input circuit and the third three phase rectifier.

14. The eighteen pulse converter system of claim 9 wherein the output circuit comprises parallel connected DC outputs from the bridge rectifiers connected through an output inductor to the DC load.

15. The eighteen pulse converter system of claim 9 wherein the set of primary windings comprises three main primary windings and each set of secondary windings comprises three main secondary windings, each in phase with corresponding ones of the three main primary windings, electrically connected to three teaser secondary windings, each in phase with adjacent ones of the three main primary windings, resulting in a vector phase shifted from the phase of the corresponding one of the three main primary windings.

16. An AC/DC converter system comprising:
an input circuit comprising a three phase inductor for connection to a three phase AC source;
an isolation transformer comprising a set of primary windings and first and second sets of secondary windings magnetically coupled to the set of primary windings, the first and second sets of secondary windings phase shifted by select amounts from the set of primary windings, the set of primary windings connected to the input circuit;
an AC/DC converter comprising first, second and third three phase rectifiers each for converting AC power to DC power;
the first three phase rectifier being electrically connected to the first set of secondary windings;
the second three phase rectifier being electrically connected to the second set of secondary windings;
an impedance matching inductor electrically connected between the input circuit and the third three phase rectifier; and
an output circuit for connection between the AC/DC converter and a DC load.

17. The AC/DC converter system of claim 16 wherein the first and second sets of secondary windings are phase shifted by +20 electrical degrees and −20 electrical degrees, respectively, from the set of primary windings.

18. The AC/DC converter system of claim 16 wherein each of the three phase rectifiers comprises a six pulse rectifier.

19. The AC/DC converter system of claim 1 wherein the output circuit comprises parallel connected DC outputs from the bridge rectifiers connected through an output inductor to the DC load.

20. The AC/DC converter system of claim 16 wherein the set of primary windings comprises three main primary windings and each set of secondary windings comprises three main secondary windings, each in phase with corresponding ones of the three main primary windings, electrically connected to three teaser secondary windings, each in phase with adjacent ones of the three main primary windings, resulting in a vector phase shifted from the phase of the corresponding one of the three main primary windings.
